(19) United States
(12) Patent Application Publication
(10) Pub. No.: US 2024/0176046 A1
(43) Pub. Date: May 30, 2024

(54) SYSTEM AND METHOD FOR FORECASTING IMPACT OF CLIMATE CHANGE

(71) Applicants: Christian Klose, Bronxville, NY (US); Shelly Klose, Bronxville, NY (US)

(72) Inventors: Christian Klose, Bronxville, NY (US); Shelly Klose, Bronxville, NY (US)

(21) Appl. No.: 18/523,866

(22) Filed: Nov. 29, 2023

Related U.S. Application Data
(60) Provisional application No. 63/428,917, filed on Nov. 30, 2022.

(51) Int. Cl. G01W 1/10

(52) U.S. Cl. CPC G01W 1/10

(57) ABSTRACT

A system and method designed to assess the future socio-economic impacts of weather events relative to variable climatic conditions is described. The techniques described include a complex data aggregation process pulling data from a heterogeneous set of sources and formats. The aggregation is followed by translating, pruning and pre-processing image data. A neural network is then trained on the pre-processed image data. The trained neural network is then designed to provide an output relative to a prompt, including estimations of economic impacts of peril severity and frequency; estimations on impact of future settlement, and probabilistic layers of future climate events.

### CROSS REFERENCE TO RELATED APPLICATIONS

This application claims the benefit of U.S. Provisional Application Ser. No. 63/428,917 filed on Nov. 30, 2022, entitled “Methods and Systems for Forecasting Impact of Climate Changes,” which is hereby incorporated by reference in its entirety.

### BACKGROUND OF THE INVENTION

The present application relates to computer systems and corresponding methods for predicting climate change and the impacts thereof.

Humans have been releasing greenhouse gasses that are contributing to warming the Earth's climate, including carbon dioxide. Greenhouse gasses have affected weather patterns around the world, causing changes in temperature and rainfall. The effects of greenhouse gasses are different in different parts of the world, so some places are affected more than others.

Tropical cyclones (TCs) are a type of natural disaster that cause the most damage to homes and property. In the United States, they have caused over $480 billion in damage over the last ten years. As the climate warms, these storms are expected to become stronger and more dangerous, with stronger winds, heavier rainfall, and higher waves. The damage caused by these storms increases quickly and dramatically as they become stronger. The amount of damage also depends on where the storm hits, with more damage occurring in areas with more people. To better protect people who live near the coast, a better understanding of how these storms might change in the future is needed.

Floods too are weather events that negatively impact a lot of people. From 1995 to 2015, over 2.2 billion people were affected by floods—that's more than half of all people affected by bad weather. Wildfires are also a type of peril with heightened severity since the late 2010s due to increasing global temperatures based, at least in part, from an increase in solar radiation reaching the earth's surface. Knowing what's happening on the ground is important when trying to help people during disasters. Today, pictures taken from satellites in space are one of the best ways to get this information. Scientists use two types of satellite pictures—one that uses light to take pictures (called “optical”) and one that uses special radar to see through clouds and take pictures (called “SAR”)—to figure out how bad the floods are and what kind of help is needed.

Traditional models used to predict natural disasters are limited to historical data, and therefore cannot predict unprecedented events. For example, Hurricane Harvey of 2017 was much different from any other hurricane we have seen before. Harvey's most catastrophic impact was the unprecedented rainfall, making it the wettest storm system on record. The storm lingered over Texas for days, causing record-breaking flooding in Houston, where some areas reported approximately 50 inches of rain. Hurricane Otis of 2023 caused catastrophic damages on the west coast of Mexico. The cyclone was unusual too. It intensified within 24 hours from a tropical storm to a category 5 hurricane. Considering our ever-changing environment, climate events may happen differently in the future than they do now, so the current models based on historical data may not be accurate.

To take climate change into consideration, people who create and use models to predict losses caused by natural disasters often change how often events happen or change the data they use to make their predictions. For example, they might estimate that stronger hurricanes will hit Miami more often or change how much rain is expected in a year based on climate predictions.

The current models used to predict losses from natural disasters are limited because they only account for events and years that we have already experienced. These models cannot accurately predict events that have never happened before or account for how events may change in the future due to climate change. Merely estimating an increase in the frequency of events in these models doesn't account for how climate change can impact other factors, such as the severity of events or the availability of fuel sources for wildfires. These models also tend to focus on specific perils and regions, but climate change can have broader effects on different types of events and regions. These models are slow to update and can be several years behind in terms of incorporating new scientific research and data. Given the increasing severity of weather and other events, a new approach is needed to better predict the impacts of climate change on natural disasters.

### SUMMARY OF THE INVENTION

Embodiments of the disclosure concern predictive climate based analytics. A first embodiment includes a method for aggregating climate event data images, climate model images and environmental data images. The method may include normalizing the climate event data images, climate model images and environmental data images with an equal geolocation value and resolution value. The method may further include pre-processing the climate event data images, climate model images and environmental data images. According to one embodiment, the method may include training a machine learning model with the pre-processed climate event data images, climate model images and environmental data images. The method may also include generating relationship information gleaned from the machine learning model trained with the pre-processed climate event data images, climate model images and environmental data images. Additionally, the method may further include producing a visual representation of a predictive climate event based on the relationship information gleaned from the machine learning model.

According to one embodiment, the climate event data images are derived from climate events including a heat based climate event, a cold based climate event, a wind based climate event, a drought based climate event, a seismic based climate event and a wind based climate event. The climate event data images may be derived from a tracking data set. The method of predictive climate base analytics may further include translating the tracking data set into an image raster format. In one embodiment, climate model images are outputs from a component computer program code representing at least a portion of a climate system. Additionally, the climate system may include an atmosphere component, an ocean component, a land surface component, an ice component and an ecosystem component. In one embodiment, the environmental data images include a plurality of temperature images, a plurality of wind images, a plurality of pressure images, a plurality of humidity images, a plurality of carbon dioxide images and a plurality of pollen images.

According to one embodiment, the method may include pre-processing the climate event data images, climate model images and environmental data images, which may include transforming the climate event data images, climate model images and environmental data images from a native format to a translated format having a common geolocation position, a common image size and a common resolution. Additionally, embodiments may include generating a pixel-by-pixel predictive image layer depicting a probability of a future climate event. Training the machine learning model may include inputting the pre-processed climate event data images, climate model images and environmental data images into a neural network. In one embodiment, the neural network is convolutional neural network wherein the convolutional neural network includes a plurality of layers of progressive complexity. For example, the plurality of layers may include a first convolutional layer, a pooling layer and a fully-connected layer. Some embodiments may further include a second convolutional layer. In one embodiment, the method may include identifying a plurality of spatial locations of the occurrences of perils relative to changing environmental and climatic conditions based on climate event data images, climate model images and environmental data images and identifying one or more geographic regions impacted by the identified one or more occurrences of perils.

The method may further include forecasting future peril occurrences including identifying spatial locations of the occurrences of perils such as floods, hurricanes, storm surges, wildfires, hail and winter storms with respect to changing future environmental and climatic conditions according to climate model forecasts. The method may further include estimating socio-economic impacts of future perils including identifying geographic regions that are negatively or even positively impacted by future climate conditions. While the aforementioned perils have a negative impact, positive impacts may be related to an increase in agricultural output in northern economies like Canada or Scandinavia.

The method, according to one embodiment, may include presenting a visual input mode permitting a user to input one or more initial conditions within at least one of the climate event data images, climate model images or environmental data images. The method may additionally include receiving the one or more initial conditions inputted by the user and transmitting the received one or more initial conditions to the machine learning model for training. In one embodiment, the method may include identifying, via the machine learning model, an affected geolocation based on the initial conditions inputted by the user and visually presenting the affected geolocation layered over at least one of the climate event data images, climate model images or environmental data images.

According to one embodiment, a system for predictive climate based analytics includes a processor and a memory comprising instructions that, when executed, cause the processor to: aggregate climate event data images, climate model images and environmental data images. The system may further include memory comprising instructions that, when executed, further cause the processor to normalize the climate event data images, climate model images and environmental data images with an equal geolocation value and resolution value. In one embodiment, the system may pre-process the climate event data images, climate model images and environmental data images and train a machine learning model with the pre-processed climate event data images, climate model images and environmental data images. The system for predictive climate based analytics may generate relationship information gleaned from the machine learning model trained with the pre-processed climate event data images, climate model images and environmental data images. According to one embodiment, the system may produce a visual representation of a predictive climate event based on the relationship information gleaned from the machine learning model.

The system may further include memory comprising instructions that, when executed, further cause the processor to generate a pixel-by-pixel predictive image layer depicting a probability of a future climate event. In one embodiment, the system may comprise instructions that, when executed, cause the processor to train the machine learning model with inputting the pre-processing of climate event data images, climate model images and environmental data images into a neural network. In one embodiment, the system may implement the neural network as a convolutional neural network.

Additional aspects of the present invention will be apparent in view of the description which follows.

### BRIEF DESCRIPTION OF THE FIGURES

FIG. 1 is a flow diagram illustrating modeling and prediction processes;

FIG. 2 is a flow diagram illustrating image preparation and predictive processing;

FIG. 3 is a flow diagram illustrating a predictive climate analytics process;

FIG. 4 is a sample HURDAT2 data;

FIG. 5 is a network diagram;

### DETAILED DESCRIPTION OF THE INVENTION

The present application is described in the following examples, which are set forth to aid in the understanding of the invention and should not be construed to limit in any way the scope of the invention as defined in the claims which follow thereafter.

A computer-implemented method and corresponding system is provided that is designed to assess the future socio-economic impacts of perils related to a changing climate in the future. The system utilizes, for example, one or more of the following datasets and/or models.

### Sample Datasets

One example dataset is HURDAT2. HURDAT2 includes the location data of hurricane tracks, e.g., provided by the National Oceanic and Atmospheric Administration. This dataset has a comma-delimited, text format with six-hourly information on the location, maximum winds, central pressure, and (beginning in 2004) size of all known tropical cyclones and subtropical cyclones.

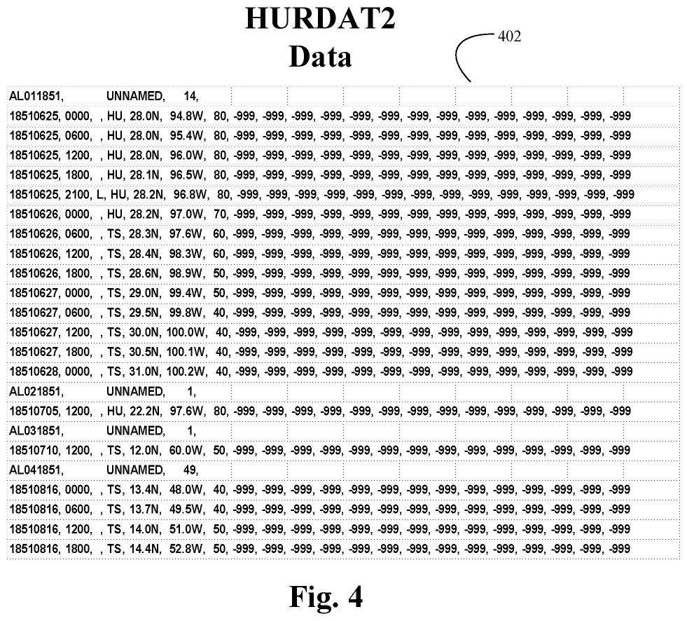

An Example of HURDATA2 may be seen in FIG. 4. The format of this HURDAT2 (HURricane DATa 2nd generation)—is based upon the “best tracks” available from the b-decks in the Automated Tropical Cyclone Forecast (ATCF—Sampson and Schrader 2000) system database and is described below. Reasons for the second generation include: 1) inclusion of non-synoptic (other than 00, 06, 12, and 18Z) best track times (mainly to indicate landfalls and intensity maxima); 2) inclusion of non-developing tropical depressions; and 3) inclusion of best track wind radii. There are two types of lines of data in the new format: the header line and the data lines. The format is comma delimited to maximize its ease in use. The header line has the following format:

AL092021, IDA, 40, 1234567890123456789012345768901234567

AL (Spaces 1 and 2)—Basin—Atlantic

09 (Spaces 3 and 4)—ATCF cyclone number for that year

2021 (Spaces 5-8, before first comma)—Year

IDA (Spaces 19-28, before second comma)—Name, if available, or else “UNNAMED”

40 (Spaces 34-36)—Number of best track entries—rows—to follow

Another example dataset includes computer readable images (of the earth or portions thereof) generated by a remote sensing device made available, e.g., through NASA's Moderate Resolution Spectroradiometer (“MODIS”). (MODIS) is a satellite-based sensor used for earth and climate measurements. Currently, there are two MODIS sensors in Earth orbit: one on board the Terra (EOS AM) satellite and one on board the Aqua (EOS PM) satellite, launched in 2002.

In one embodiment, MODIS instruments capture data in 36 spectral bands ranging in wavelength from 0.4 μm to 14.4 μm and at varying spatial resolutions (2 bands at 250 m, 5 bands at 500 m and 29 bands at 1 km). The MODIS instruments image the entire Earth every 1 to 2 days. They are designed to provide measurements in large-scale global dynamics including changes in Earth's cloud cover, radiation budget and processes occurring in the oceans, on land, and in the lower atmosphere. MODIS data may include MODIS level 1 data, cloud mask, and atmosphere products. MODIS data may also include land products. In one embodiment, MODIS data may include cryosphere products. Additionally, MODIS data may include ocean color and sea surface temperature products.

Similar to the computer readable images from MODIS, another dataset of images may be retrieved from the Visible Infrared Imaging Radiometer Suite (“VIIRS”). VIIRS is a whiskbroom scanner radiometer that collects imagery and radiometric measurements of the land, atmosphere, cryosphere, and oceans in the visible and infrared bands of the electromagnetic spectrum. VIIRS is capable of generating two data processing streams that result in two different sets of land products, with global coverage every 14 hours. These are known as environmental data records (“EDRs”). The other stream is from NASA, and is intended to contribute to the larger scientific community. These are known as Earth System Data Records (“ESDRs”).

Another example dataset includes computer readable images of natural and anthropogenic emissions (e.g., NOx, Ozone, PM2.5) generated, e.g., by Copernicus Atmosphere Monitoring Service (“CAMS”). CAMS provides consistent and quality-controlled information related to air pollution and health, solar energy, greenhouse gasses and climate forcing, everywhere in the world. CAMS data provides the ability to forecast information on air quality, pollen concentrations as well as conduct simulations. The Copernicus Atmosphere Data Store (“ADS”) is the data access portal of the Copernicus Atmosphere Monitoring Service CAMS and offers access to data about the Earth's past, present and future atmosphere. Access to ADS may be typically accomplished interactively via the ADS web interface, or programmatically with an API. The ADS web interface allows users to interactively browse, select and download data products offered by the ADS. After reviewing the available datasets, a user browses and selects the data through a download form providing a. Next, the user may specify details of the data download form and submit. Accessing data from the ADS typically requires account registration and authentication.

Another method of accessing data is through the CDS Application Program Interface (“CDS API”). The CDS Application program is a Python library which allows a user to access data from the ADS programmatically. The steps to use the API (Application Programming Interface) may include installing an API key, account creation and authentication.

Another example dataset includes computer readable images produced by various climate models available through the Coupled Model Intercomparison Project Phase 6 (“CMIP6”) of the World Climate Research Programme (“WCRP”). CMIP6 coordinates somewhat independent model intercomparison activities and experiments which have adopted a common infrastructure for collecting, organizing, and distributing output from models performing common sets of experiments. Access to CMIP6 data may be accomplished through a search interface.

In one embodiment, CMIP6 output may be stored in files with at least one variable stored per file. In one embodiment, the data may be “cmorized” (i.e., written in conformance with the CMIP standards). The CMIP standards build on conventions, which define metadata that provide a description of the variables and their spatial and temporal properties. This facilitates analysis of the data by users who can read and interpret data from all models in the same way. The CMIP6 data requirements for modelers may include definition global attributes, controlled vocabularies, specifications for file names, directory structures, and CMIP6 Data Reference Syntax (DRS), output file content, structure, and metadata, guidance on grid requirements, information on pressure levels requested and guidance on time-averaging (with masking). Additional metadata requirements may be imposed on a variable by variable basis.

Computer readable images that measure the exposure of the global population in space or by country that are generated by various data providers including but limited to Center for International Earth Science Information Network (“CIESIN”), The World Bank (WB), Organization for Economic Co-operation and Development (OECD) and United Nations (UN). These tools may include data visualization tools, population mapping tools, flood impact tools, and the like.

In a preferred embodiment, the computer program, first, reads peril data, such as, for instance, the hurricane track data (HURDAT2), flood locations, or wildfires. Then, locations of the perils are potentially resized to a desired format (pre-processing). Specifically, the geolocations of these perils (e.g., tracks) are translated by the computer program into image raster formats, e.g., Earth images, maps etc., that are comparable to the size and resolution of the CMIP6, MODIS, and CAMS images, which contain environmental and climate data (e.g., temperature, wind speed, pressure). Other image data, such as elevation data or ocean altimetry (tides), may also be resized to the resolution of the CMIP6, MODIS, and CAMS images. In this regard, the resulting images include atmospheric, as well as the peril data, on a per pixel basis.

Second, the computer program may predict a likelihood of annual occurrence of a given peril or a plurality of perils in an image pixel, based on the provided climatic and environmental states within the same pixel. Pixels in combination may provide a map of probabilities of occurrences of a given peril or a set of multiple perils. These maps may provide insights on the future of the spatial distributions of perils given the changing environmental and climatic conditions over time. For example, tropical storms might propagate further to the coastal north, wildfires might also occur further in the north or floods might occur more inland. In one embodiment, the output of the forecasted natural hazard conditions may allow users to: 1) Estimate economic impacts of peril severities and frequencies (e.g., storm and flood damages along coastlines, crop yield decline in agriculture); 2) Protect against future increase of peril severities and frequencies (e.g., building back infrastructure, storm gates, flood walls); 3) Estimate the impact of future settlements (e.g., migration of climate refugees that lost their land that is predicted to be uninhabitable); 4) Gamify socio-economic outcomes. (Users could interact as part of a strategy game to make decisions during the game).

According to one embodiment, the computer implemented methods and system provide a visual presentation of information regarding the probability of the occurrence of a given peril. In one embodiment, the process may begin with collecting one or more images and identifying the geographic locations and regions therein. The collection process may be accomplished, for example, with the user obtaining a plurality of climate model image outputs and environmental data as images. Environmental data as images may include a ground elevation image, surface temperature image and/or ocean altimetry image (tides). Preferably, the image is in a digital image format for further processing and analysis. Digital images may be stored as raster or vector files.

A raster image file is a rectangular array of regularly sampled values, known as pixels. Each pixel (picture element) has one or more numbers associated with it, specifying a color which the pixel should be displayed in. The simplest representation of an image has each pixel specified by three 8 bit (24 bits total) color values (ranging from 0-255) defining the amount of red, green, and blue respectively in each pixel. In the right proportions, red, green, and blue can be combined to form black, white, 254 shades of gray, and a vast array of colors (16,777,216 colors total). Raster image formats may include JPEG, PNG, GIF, TIFF, RGB, PPM, PSD and RAW.

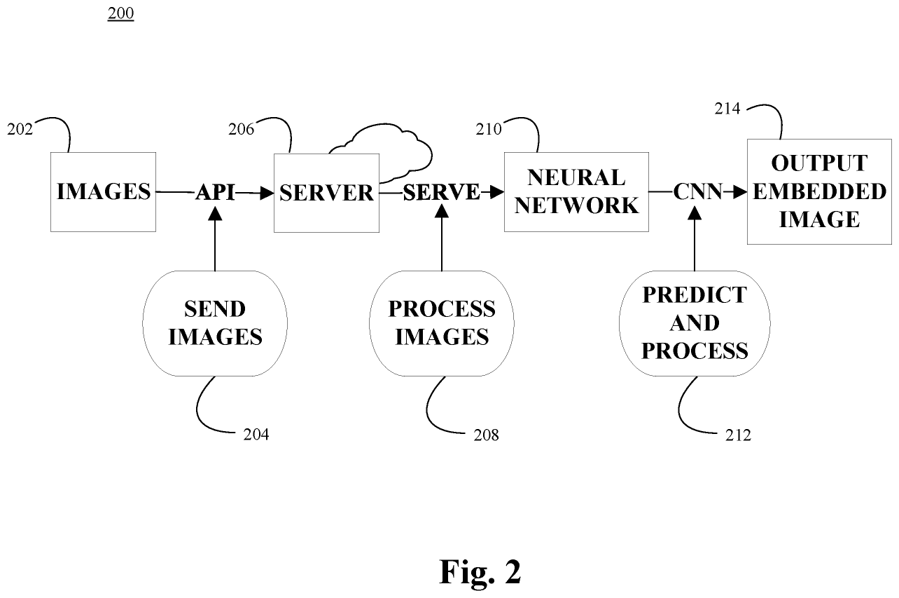

According to one embodiment, images may have a resolution of at least 0.5×0.5 degree in latitude and longitude. This may permit a user to derive useful information from the analysis, given that 0.5 degree is about 55 km or 34 miles. In one embodiment, the available images may be sent via an API to a remote server in the cloud, together with an API key where the images are getting pre-processed at first. According to one embodiment, the pre-processing might include a rescaling to a recommended image size and image raster format. After pre-processing, the images may be analyzed by a machine learning based model. (See, FIG. 2). After the images are pre-processed, the image width and image height parameters may be collected.

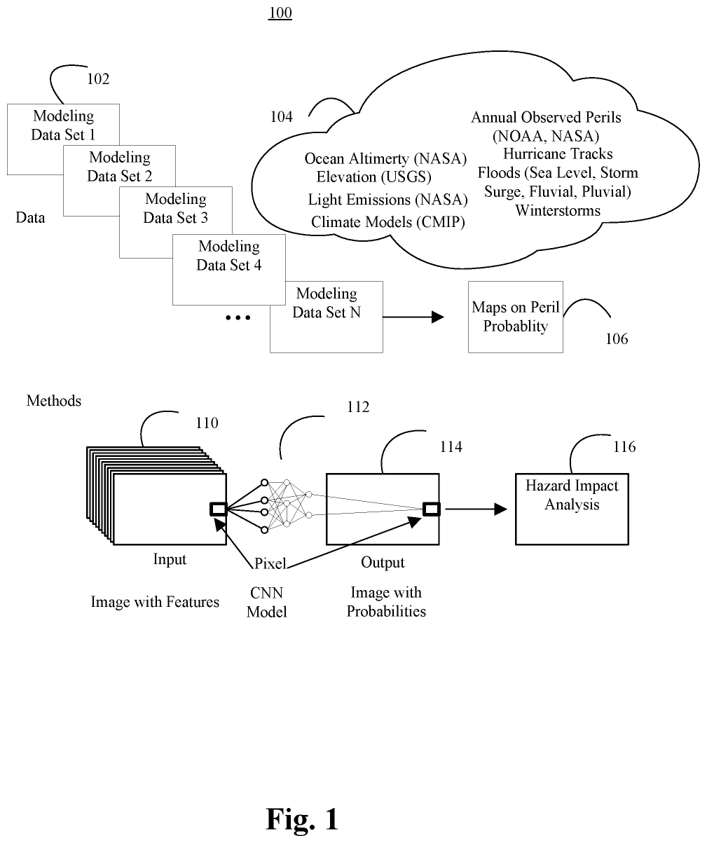

According to one embodiment, the collected images of a region are then presented to a convolutional neural network (CNN). Advantageously, the CNN learns relationships in data that may otherwise seem distant and seem spatially unrelated. For example, it is expected that the Arctic ice melting will accelerate the sea level rise on the U.S. east coast. A CNN may learn from past observations where data is available (2006-2022) and predict the outcome for future years, e.g., 2050. (See, Output, FIG. 1).

In one embodiment, a trained neural network may be applied to monitor short or long-term changes in areas of interest regarding a designated set of parameters. The designated set of parameters may include precipitation pattern, occurrence probabilities and/or severity of hurricanes or wildfires. The trained neural network may provide a variety of outputs including various forecasts. These forecasts may include a forecast of peril severity, a forecast of peril frequency and a forecast of socio-economic changes.

Advantageously, the trained neural network, by developing relationships among large data sets can output these predictive forecasts. With respect to the forecast of peril severity, there may exist an expectation of increasing peril severity. This increase may be due to the changing climate, leading to alterations in future climate conditions that will influence weather patterns. For example, regions such as the Tri-State area of New York, Connecticut, and New Jersey may experience peril severity such as heightened precipitation. This increased likelihood of peril severity may not be primarily attributed to hurricanes bringing moisture from the tropical areas up north, but rather to the overall increase in atmospheric moisture related to the global mean temperature rise. Additionally, larger weather systems, such as atmospheric rivers, could bring substantial precipitation to regions that have historically seen lower rainfall. These types of data, and the analysis of a trained neural network, may lead to predictive analytics expressing, through various output modalities, more precipitation than previously experienced.

With respect to forecasts of peril frequency, again the trained neural network develops relationships across large data sets and can express those relationships as predictive analytics. For example, one data set may include measurements related to the melting of the ice shields in the Arctic region. Another data set may measure the velocity and direction of ocean currents. When analyzed together, for example, the trained neural network may determine an increase in the melting of ice shields in the Arctic region is anticipated to alter ocean currents in speed and direction. This relationship, gleaned from the insights developed by the neural network, may predictively suggest an increase in the number of Category 5 hurricanes to reach parts further north in the hemisphere. Additionally, another predictive analytic may include the melting of ice shields could decrease the return period of a Category 5 hurricane from 130 years to 80 years.

With respect to forecasts of socio-economic changes, prior iterations of weather or climate data were simply never combined with socio-economic conditions, like population density and socio-economic resources. Historically, state or federal governments have absorbed perils through relief funds available after major events (e.g., the 2003 European heatwave, 2005 Hurricane Katrina). The severity of such events continues to grow due to unfavorable socio-economic incentives that local governments may have allowed in the past.

A trained neural network and predictive model may indicate an increased likelihood of migration away from low-resilient regions prone to future flooding or sea-level rise. For example, this migratory trend is currently observed in 2022 by people in the coastal areas of Bangladesh, who migrate to Dhaka. Such slow or fast migration forecasts could be very helpful for economic model forecasts as performed by a number of third-party institutions.

When considering the number of climate models predicting different outcomes of the future climate state, each of these models may result in different predicted expected probabilities of a given peril within a given year. In one embodiment, each predicted outcome may be averaged for each location on a pixel by pixel manner and provided as mean and variance likelihood of occurrence. This probability may be presented in the pixel in a variety of ways, including alpha-numerical or visual. For example, the visual presentation may be in color representing a high vs. a low mean probability. In one embodiment, the color may be overlaid over the image and may vary in transparency so that features in the original image may be visible. In additional embodiments, mean probabilities and variances of the probabilities can be expressed with respect to peril type and occurrence, e.g.:

What is the probability of occurrence of hurricanes in New England in the year 2050 along the U.S. Atlantic coast having at least one hurricane making landfall within a year or having more than five hurricanes making landfall within a year?

What is the probability of occurrence in 2100 of coastal inundation in Miami Dade county Florida, USA or in the Chittagong Division of Bangladesh (and the associated population migration) due to sea level rise under a CMIP climate scenario of 1.5 degree Celsius atmospheric temperature increase?

FIG. 1 is a flow diagram 100 illustrating modeling and prediction processes. In one embodiment, a plurality of data sets and climate models may be collected 102. These may include Ocean Altimetry (NASA), Elevation (USGS), Light Emissions (NASA), Climate Models (CMIP), Annual Observed Perils (NOAA, NASA) 104. The annual observed perils may include hurricane tracks, floods (sea level, storm surge, fluvial, pluvial, and/or the like). The modeling of relationships between CMIP, NASA and USGS, pixel data may be used to determine a probability of occurrence of perils. Other embodiments may incorporate other pixel data without departing from the scope of the techniques described herein. In addition, modeled relationships between the pixel data may, in one embodiment, generate a map or a plurality of maps on peril probability 106.

According to one embodiment, a timeline may be broken up into the past and future. Modeling of relationships with historical or past data (textual/numerical, image/pixel, video, modeling data) may assist to determine the probabilities of occurrence of peril events. In one embodiment, predicting probabilities of occurrence of perils may be based, at least in part, on observed climate states and seasonal variabilities from the historical data.

Also depicted in FIG. 1 is at least one example of a process according to one embodiment. The process includes receiving input, for example, images with features. The input may then be sent to a machine learning algorithm. As shown in FIG. 1, the machine learning algorithm may include a Convolutional Neural Network 112. (“CNN”). According to one embodiment, a CNN may be comprised of one or more convolutional layers (preferably, with a subsampling step) and then followed by one or more fully connected layers as in a multilayer neural network. The architecture of a CNN is designed to take advantage of the 2D structure of an input image (or other 2D input such as a speech signal). This may be achieved with local connections and tied weights followed by some form of pooling which results in translation invariant features. One benefit of CNNs is that they may have fewer parameters than fully connected networks with the same number of hidden units.

In one embodiment, the architecture of a CNN implementation may consist of a number of convolutional and subsampling layers optionally followed by fully connected layers. Preferably, at least one layer of the CNN includes a feature detector, also known as a kernel or a filter, that may move across the receptive fields of the image, checking if the feature is present. According to one embodiment, the CNN's 112 feature detector is a two-dimensional (2-D) array of weights, which represents part of the image. While feature detectors may vary in size, the filter size may be a 3×3 matrix; which may also determine the size of the receptive field. As illustrated, the filter may be applied to an area of the image, and a dot product is calculated between the input pixels and the filter. This dot product may then be fed into an output array. Afterwards, the filter preferably shifts by a stride, repeating the process until the kernel has swept across the entire image. The final output from the series of dot products from the input and the filter is known as a feature map, activation map, or a convolved feature. While other architectures of a CNN are possible, the above noted architecture should be noted to provide one sample implementation.

According to one embodiment, the output 114 may include an image with probabilities. The described technique may further include a hazard impact analysis 116. As noted above, the hazard impact analysis may include mean probabilities and variances of the probabilities can be expressed with respect to peril type and its occurrence.

FIG. 2 is a flow diagram 200 illustrating image preparation and predictive processing. The flow diagram of FIG. 2 depicts image preparation and processing to predict peril likelihoods and socio-economic impact in the future. In one embodiment, the flow may include a user collecting and/or receiving images from a variety of data sources 202. In some embodiments, image data may be downloaded or accessed through an API. 204. Once collected, the images may be pre-processed into a prescribed format for consistent analysis 208. The pre-processed images may be served or fed into a neural network 210. In one embodiment the neural network is a CNN. However, different types of neural networks may be employed. For example, a feed forward neural network, a recurrent neural network, a deconvolutional, a LSTM Long-Short-Term Memory neural network, a modular neural network, perceptron, radial basis functional neural network and/or a transformer based neural network. According to one embodiment, the neural network 210 is trained and then prompted to predict and process 212. The prompts may then provide an output. In one embodiment, the output may include an embedded image output 214. For example, the predictive probabilities of a future peril may be visually embedded or layered on top of a map or a plurality of maps with variable and configurable visibilities depending on user preferences.

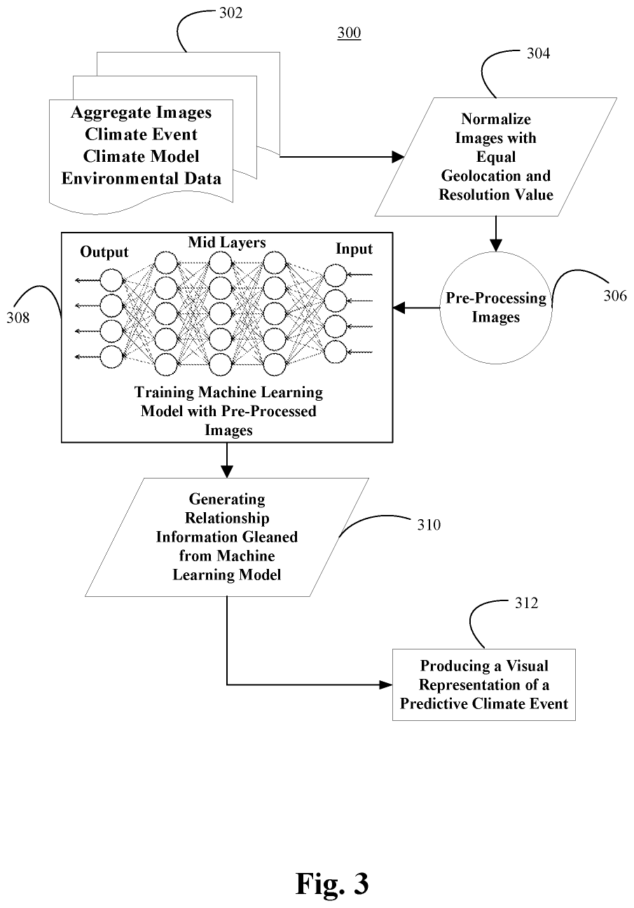

FIG. 3 is a flow diagram 300 illustrating a predictive climate analytics process. The flow diagram may include a step of aggregating climate event data images, climate model images and environmental data images 302. In one embodiment, the technique depicted in FIG. 3 may include normalizing the climate event data images, climate model images and environmental data images with an equal geolocation value and resolution value 304. The flow diagram further illustrates the step of pre-processing the climate event data images, climate model images and environmental data images 306. In one embodiment, the technique may include training a machine learning model with the pre-processed climate event data images, climate model images and environmental data images 308. The flow diagram further illustrates generating relationship information gleaned from the machine learning model trained with the pre-processed climate event data images, climate model images and environmental data images 310. In one embodiment, the flow includes producing a visual representation of a predictive climate event based on the relationship information gleaned from the machine learning model 312.

FIG. 4 illustrates HURDAT2 data. As noted above, HURDAT2 data may include the location data of hurricane tracks. This dataset has a comma-delimited, text format with six-hourly information on the location, maximum winds, central pressure, and size of all known tropical cyclones and subtropical cyclones.

The above noted method and system may be implemented over a network. Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

Any node may include a processor in communication with memory. Generally, any mechanization allowing a processor to affect the storage and/or retrieval of information is regarded as memory. Any number of memory embodiments may be employed in lieu of or in concert with one another. It is to be understood that a bus controller and/or a computer systemization may employ various forms of memory. For example, a computer system may be configured wherein the operation of on-chip CPU memory (e.g., registers), RAM, ROM. In a typical configuration, memory will include ROM, RAM, and a storage device. A storage device may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blu Ray, CD ROM/RAM/Recordable (R)/ReWritable (RW), DVD R/RW, HD DVD R/RW etc.); RAM drives; non-transient memory, solid state memory devices (USB memory, solid state drives (SSD), etc.); other processor-readable storage mediums; and/or other devices of the like.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A method for predictive climate based analytics, comprising:
aggregating climate event data images, climate model images and environmental data images;
normalizing the climate event data images, climate model images and environmental data images with an equal geolocation value and resolution value;
pre-processing the climate event data images, climate model images and environmental data images;
training a machine learning model with the pre-processed climate event data images, climate model images and environmental data images;
generating relationship information gleaned from the machine learning model trained with the pre-processed climate event data images, climate model images and environmental data images; and
producing a visual representation of a predictive climate event based on the relationship information gleaned from the machine learning model.

2. The method of claim 1, wherein the climate event data images are derived from climate events including a heat based climate event, a cold based climate event, a wind based climate event, a drought based climate event, a seismic based climate event and a wind based climate event.

3. The method of claim 1, wherein the climate event data images are derived from a tracking data set.

4. The method of claim 3, comprising:
translating the tracking data set into an image raster format.

5. The method of claim 1, wherein climate model images are outputs from a component computer program code representing at least a portion of a climate system.

6. The method of claim 5, wherein a climate system includes an atmosphere component, an ocean component, a land surface component, an ice component and an ecosystem component.

7. The method of claim 1, wherein environmental data images include a plurality of temperature images, a plurality of wind images, a plurality of pressure images, a plurality of humidity images, a plurality of carbon dioxide images and a plurality of pollen images.

8. The method of claim 1, wherein the step of pre-processing the climate event data images, climate model images and environmental data images includes transforming the climate event data images, climate model images and environmental data images from a native format to a translated format having a common geolocation position, a common image size and a common resolution.

9. The method of claim 1, comprising:
generating a pixel-by-pixel predictive image layer depicting a probability of a future climate event.

10. The method of claim 1, wherein training the machine learning model includes inputting the pre-processed climate event data images, climate model images and environmental data images into a neural network.

11. The method of claim 10, wherein the neural network is convolutional neural network.

12. The method of claim 10, wherein the convolutional neural network includes a plurality of layers of progressive complexity.

13. The method of claim 12, wherein the plurality of layers include a first convolutional layer, a pooling layer, a fully-connected layer and a second convolutional layer.

14. The method of claim 1, further comprising:
identifying a plurality of spatial locations of one or more occurrences of perils relative to changing environmental and climatic conditions based on climate event data images, climate model images and environmental data images; and
identifying one or more geographic regions impacted by the identified one or more occurrences of perils.

15. The method of claim 1, further comprising:
presenting a visual input mode permitting a user to input one or more initial conditions within at least one of the climate event data images, climate model images or environmental data images;
receiving the one or more initial conditions inputted by the user;
transmitting the received one or more initial conditions to the machine learning model for training.

16. The method of claim 1, further comprising:
identifying, via the machine learning model, an affected geolocation based on the initial conditions inputted by the user; and
visually presenting the affected geolocation layered over at least one of the climate event data images, climate model images or environmental data images.

17. A system for predictive climate based analytics, the system comprising:
a processor; and
a memory comprising instructions that, when executed, cause the processor to:
aggregate climate event data images, climate model images and environmental data images;
normalize the climate event data images, climate model images and environmental data images with an equal geolocation value and resolution value;
pre-process the climate event data images, climate model images and environmental data images;
train a machine learning model with the pre-processed climate event data images, climate model images and environmental data images;
generate relationship information gleaned from the machine learning model trained with the pre-processed climate event data images, climate model images and environmental data images; and
produce a visual representation of a predictive climate event based on the relationship information gleaned from the machine learning model.

18. The system of claim 17, further comprising instructions that when executed, cause the processor to:
generate a pixel-by-pixel predictive image layer depicting a probability of a future climate event.

19. The system of claim 17, further comprising instructions that when executed, cause the processor to:
train the machine learning model with inputting the pre-processing of climate event data images, climate model images and environmental data images into a neural network.

20. The system of claim 17, further comprising instructions that when executed, cause the processor to:
implement the neural network as a convolutional neural network.
